(19) United States
(12) Patent Application Publication
(10) Pub. No.: US 2013/0333039 A1
(43) Pub. Date: Dec. 12, 2013

(54) Evaluating Whether to Block or Allow Installation of a Software Application

(71) Applicant: Nicholas Paul Kelly, Buckinghamshire (GB)

(72) Inventor: Nicholas Paul Kelly, Buckinghamshire (GB)

(73) Assignee: MCAFEE, INC., Santa Clara, CA (US)

(21) Appl. No.: 13/490,954

(22) Filed: Jun. 7, 2012

(51) Int. Cl. G06F 21/00

(52) U.S. Cl. 726/24; 726/22

(57) ABSTRACT

A programmable device for which an application is to be installed analyzes permissions requested by the application and other application information to assist the user in deciding whether to allow installation of the application. The analysis may either block or allow the installation, or may provide a calculated risk level to the user and request a decision. Application information, such as a category of application, typical permissions requested by similar applications, and trustworthiness of the application source, in addition to whitelists and blacklists may be employed as part of the analysis and evaluation of the permissions. As a result, the user need not be burdened with overly technical information and may make a better informed decision on installation.

### BACKGROUND

This disclosure relates generally to the field of computer security. More particularly, but not by way of limitation, it relates to a technique for controlling the installation of applications on a programmable device.

Smartphones and other personal programmable devices often allow users to install applications on the personal programmable device to add additional functionality to the device beyond that provided by the manufacturer. While such applications can be useful and valuable to users, malware that presents a risk to the user or the programmable device is preferably not installed. Current systems for controlling installation of applications requires too much knowledge on the part of the user, and users have developed a response of accepting application installation without understanding the risks involved in installing the application, thus malware is often installed that could have been blocked if the user had understood the information about the application.

### SUMMARY

A programmable device for which an application is to be installed analyzes permissions requested by the application and other application information to assist the user in deciding whether to allow installation of the application. The analysis may either block or allow the installation, or may provide a calculated risk level to the user and request a decision. Application information, such as a category of application, typical permissions requested by similar applications, and trustworthiness of the application source, in addition to whitelists and blacklists may be employed as part of the analysis and evaluation of the permissions. As a result, the user need not be burdened with overly technical information and may make a better informed decision on installation.

A method is disclosed, wherein the method comprises receiving a request to install an application on a programmable device; and deciding whether to install the application, wherein deciding whether to install the application comprises determining a risk level of the application responsive to a set of permissions requested by the application; and blocking installation of the application if the risk level exceeds a predetermined risk threshold.

A system is disclosed, wherein the system comprises a processor; a storage subsystem, coupled to the processor; an application database stored on the storage subsystem comprising: information associated with applications configured for installation on a programmable client device; and software stored on the storage subsystem comprising instructions to cause the processor to perform actions, wherein the actions comprise receiving a request from the programmable client device to install an application on the programmable device; evaluating a set of permissions requested by the application; and transmitting a risk determination to the programmable client device responsive to evaluating the set of permissions.

A programmable device is disclosed, wherein the programmable device comprises a programmable control device; an operating system configured to control the programmable control device; a storage subsystem, coupled to the programmable control device; and software that when executed by the programmable control device, causes the programmable control device to perform actions comprising evaluating a set of permissions requested by an application to be installed on the programmable device to determine a risk level of the application; and blocking installation of the application if risk level exceeds a predetermined risk threshold.

### BRIEF DESCRIPTION OF THE DRAWINGS

FIG. 1 is a block diagram illustrating a technique for controlling the installation of an application on a programmable device.

FIG. 2 is a flowchart illustrating a technique for evaluating permissions requested by an application.

FIG. 3 is a block diagram illustrating a programmable device for use with techniques described herein.

FIG. 4 is a block diagram illustrating a client-server network for use with techniques described herein.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

As used herein, the term “a computer system” can refer to a single computer or a plurality of computers working together to perform the function described as being performed on or by a computer system.

Although the description below is written in terms of permissions requested by an application, any other collection of attributes requested or required by an application may be used instead of permissions.

Smart phones and other mobile programmable devices, including tablets, allow the installation of applications to extend the functionality provided by the hardware and the operating system and native applications. Where the hardware manufacturer is different from the manufacturer of the operating system that controls the programmable device, such as is commonly the case in systems using the Android operating system, the manufacturer of the hardware may modify the operating system provided by the operating system manufacturer, providing additional applications or operating system functionality, or restricting functionality as desired.

In devices using the Android operating system, for example, users may download applications from one of multiple application marketplaces for installation on their device. As part of the installation package, each application provides a manifest file that identifies what operating system capabilities (typically referred to as “permissions”), are required by the application. An application not granted a permission is prohibited by the operating system from accessing or using the associated capability. While some applications might be able to function without any permissions, most applications require one or more permissions.

Some permissions are essentially innocuous and safe. Other permissions may involve risk to the user, the user's personal data, etc. These permissions may be categorized based on the risks involved. For example, the Android operating system provides a standard set of permission groups as set forth in Table 1 below:

TABLE 1

| | |
|---|---|
| ACCOUNTS | Permissions for direct access to the |
| | accounts managed by the Account |
| | Manager. |
| COST_MONEY | Used for permissions that can be used to |
| | make the user spend money without their |
| | direct involvement. |
| DEVELOPMENT_TOOLS | Group of permissions that are related to |
| | development features. |
| HARDWARE_CONTROLS | Used for permissions that provide direct |
| | access to the hardware on the device. |
| LOCATION | Used for permissions that allow access to |
| | the user's current location. |
| MESSAGES | Used for permissions that allow an |
| | application to send messages on behalf of |
| | the user or intercept messages being |
| | received by the user. |
| NETWORK | Used for permissions that provide access |
| | to networking services. |
| PERSONAL_INFO | Used for permissions that provide access |
| | to the user's private data, such as contacts, |
| | calendar events, e-mail messages, etc. |
| PHONE_CALLS | Used for permissions that are associated |
| | with accessing and modifyign telephony |
| | state: intercepting outgoing calls, reading |
| | and modifying the phone state. |
| STORAGE | Group of permissions that are related to |
| | SD card access. |
| SYSTEM_TOOLS | Group of permissions that are related |
| | to system |

Application developers may also specify non-standard permission groups as desired.

Example permissions that may create a risk that the application using that permission may cost the user money include:

CALL_PHONE—the ability to initiate phone calls without notifying the user of the phone.

SEND_SMS—the ability to send Short Message System (SMS) messages without notifying the user of the phone.

INTERNET—the ability to open network sockets, potentially incurring data usage charges.

Example permissions that can access personal data include:

GET_ACCOUNTS—Allows access to the list of accounts in the Accounts Service.

GET_TASKS—Allows an application to get information about the currently or recently running tasks: a thumbnail representation of the tasks, what activities are running in it, etc.

READ_CONTACTS—Allows an application to read the user's contacts data.

Example permissions that can modify personal data include:

CLEAR_APP_USER_DATA—Allows an application to clear user data.

WRITE_CONTACTS—Allows an application to write (but not read) the user's contacts data.

WRITE_SMS—Allows an application to write SMS messages.

Examples of permissions can be used for tracking the user's location include:

ACCESS_COARSE_LOCATION—Allows an application to access coarse (e.g., Cell-ID, WiFi) location/

ACCESS_FINE_LOCATION—Allows an application to access fine (e.g., GPS) location.

CAMERA—Required to be able to access the camera device.

Other permissions that can be used by malicious software to do other actions that might not be desired include:

FACTORY_TEST—allows root access to the phone and could be used maliciously.

AUTHENTICATE_ACCOUNTS—Allows an application to act as an AccountAuthenticator for the AccountManager.

BRICK—Required to be able to disable the device (very dangerous!).

These categories are illustrative and by way of example only, and other categories of permissions and specific permissions defined by the operating system may be considered risky when requested by an application.

Although in the case of Android operating systems, application installation warning screens are provided specifying the requested permissions, these warning screens are often ignored, because they are often too technical for end users to determine if the permissions requested are appropriate. A better approach described herein removes the need for the end user to understand the permissions that are requested by the application at the time of installation. This simplifies application installation and gives the user additional peace of mind that an application was not malicious.

By providing the capability for a security service (which may be integrated into the operating system, installed as an application, etc.) to evaluate the permissions requested by the application and make decisions on the level of risk created by the installation of the application, the application installation procedure may provide the user with control over the installation process, without requiring knowledge of the permissions requested or their individual or collective risks. The default behavior of the security service may be configured to provide control over the action of the security service. For example, the security service may block a risky application from installing without requesting a decision by the user. Alternately, the security service may allow the user to choose to install the risky application, but give the user an indication the level of risk before making the decision to install. Although numerous techniques may be provided for such an indication, one technique may present a warning dialog that indicates a low, medium, or high risk by color coded messages, using colors such as green, yellow, and red to accentuate the risk level information. The security service may further be configurable to allow a user to specify a level of risk that would be allowed to install without user approval, for example allowing applications deemed to be at a low risk to install without requiring approval, but requiring approval for applications deemed to be at a high risk. Any number of risk levels may be defined as desired.

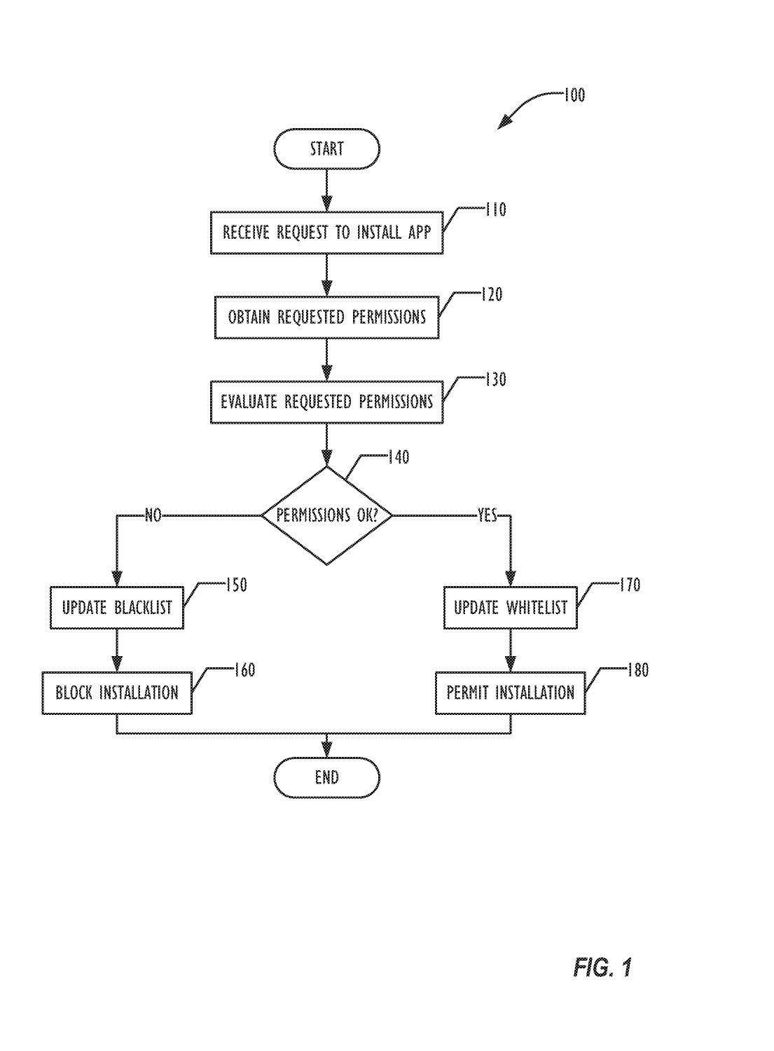

FIG. 1 is a flowchart illustrating a technique 100 for improving an application installation process on a programmable device. In block 110, the security service receives a request to install an application on the programmable device. Any desired technique for notifying the security service of the attempted installation may be used, but typically the security service will be hooked into the operating system's installation processing so that it will be called or notified of every installation.

In block 120, the requested permissions are obtained by the security service. In the case of an Android operating system, the permissions are provided by the application in a manifest file, generally formatted as an eXtended Markup Language (XML) file that is stored in the root directory of the application. Other operating systems may provide the permissions to the security service in any desired way.

In block 130, the security service evaluates the requested permissions, as described in more detail below. As a result of this evaluation, the security service determines a risk level of the application. In block 140, if the permissions create a risk level that is unacceptable, the security service may take actions to block the installation.

If the risk level is acceptable, the security service may take actions to allow the installation. Although as illustrated in FIG. 1 the security service either blocks or allows the installation based on the decision of block 140, variants of the technique may provide for user decision making, such as providing the user with the determined risk level and requesting a decision on whether to block or allow the installation. Other variants may automatically block or allow the installation for some risk levels, and request a user decision for other risk levels at intermediate levels. Any desired number of risk levels may be determined or calculated, using any desired permission-based criteria for calculating the risk levels.

As illustrated in FIG. 1, in addition to blocking the installation (160) or permitting the installation (180), the security service may update blacklists (150) of known malware applications or whitelists (170) of known good applications based on the risk level determination. An application that is determined to have a risk level that is unacceptable may be added to a blacklist in block 150, while an application that is determined to have a risk level that is acceptable may be added to a whitelist in block 170. The blacklist and whitelist may be maintained by the security service in any desired way, using any desired technique for storing information about the application. These blacklists and whitelists may be utilized during future evaluations of requested permissions, as described in more detail below.

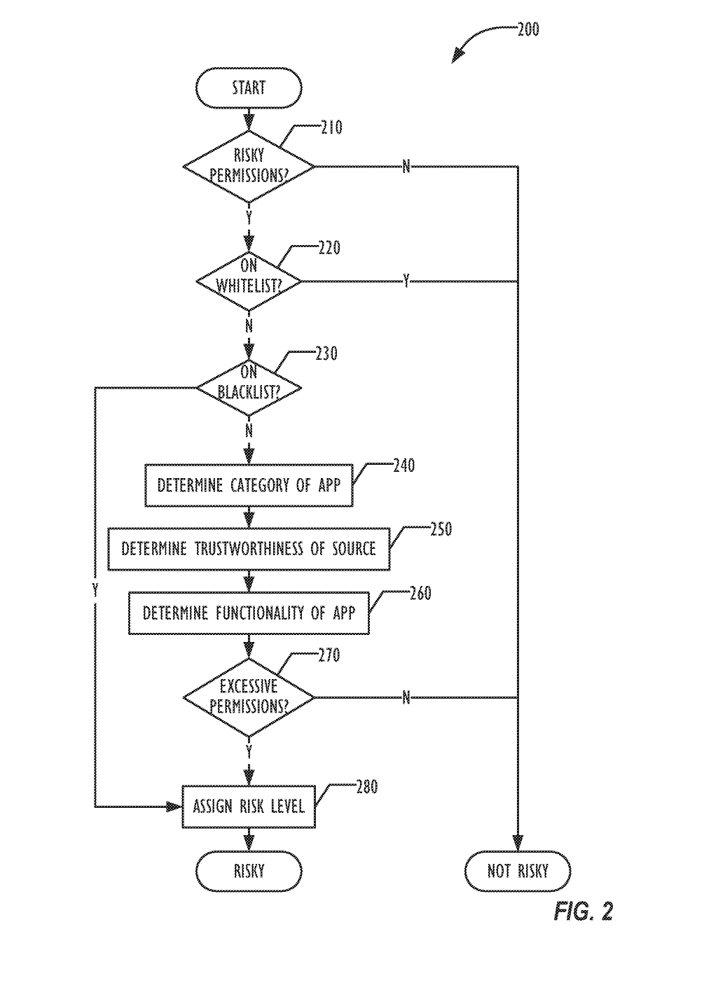

FIG. 2 is a flowchart illustrating a technique 200 for evaluating the requested permissions and assigning a risk level based on the permissions and other application-related information. As illustrated in this flowchart, applications may be determined to be risky or not risky, with risky applications assigned a risk level, which may then be compared to a predetermined risk threshold for deciding whether to allow or block installation of the application. Variants of the technique may also assign a risk level to not risky applications, using a risk level defined to indicate a low or no risk.

In block 210, the requested permissions are evaluated to determine whether any of the requested permissions are deemed risky. If no permissions are requested, or install.

If block 220, the security service may check to see if the application is listed in a whitelist. The whitelist may be maintained locally, on the programmable device, remotely on a security server, or both, as described in more detail below. If a local whitelist is maintained, then the security server may provide periodic updates to the local whitelist, either replacing the local whitelist with a new version or making changes to the local whitelist as instructed by the security server. If only a remote whitelist is maintained, then block 220 may be implemented by sending a request to the security server, receiving a response indicating whether the application is listed on the remote whitelist. If both remote and local white lists are maintained, then the local whitelist is typically checked first, then the remote whitelist, although that order may be reversed if desired. If the application is on the whitelist, then the application may be considered not risky.

In block 230, a blacklist may be checked, similar to the check of the whitelist, using either local, remote, or a mixture of local and remote blacklists. Although as illustrated in FIG. 2, both blacklists and whitelists are used, variants of the technique may employ only whitelists or only blacklists, as desired. If the application is on the blacklist, then the application may be considered risky and a risk level assigned in block 280.

In block 240, if the application is on neither the whitelist nor the blacklist, the security service may use various criteria to determine the risk level of the application. As illustrated in FIG. 2, in block 240 the application may be categorized into one of a plurality of categories found in an application marketplace. Example categories may include email, games, utilities, etc. In such a categorization of the application in an application marketplace, some categories may be considered more risky than others. In block 250, the security service may determine a trust level that indicates the trustworthiness of the source of the application. For example, applications by one author or manufacturer may be considered riskier than application by another author or manufacturer, based upon reputation data collected by the vendor of the security service. This reputation data may, like the whitelists and blacklists, may be stored and accessed locally, remotely, or as a combination of local and remote reputation data. The reputation data may include information about the number of applications by the relevant author or manufacturer have been considered safe or unsafe. In block 260, the specific functionality of the application may also be considered as defined by the application or as discovered in an application database.

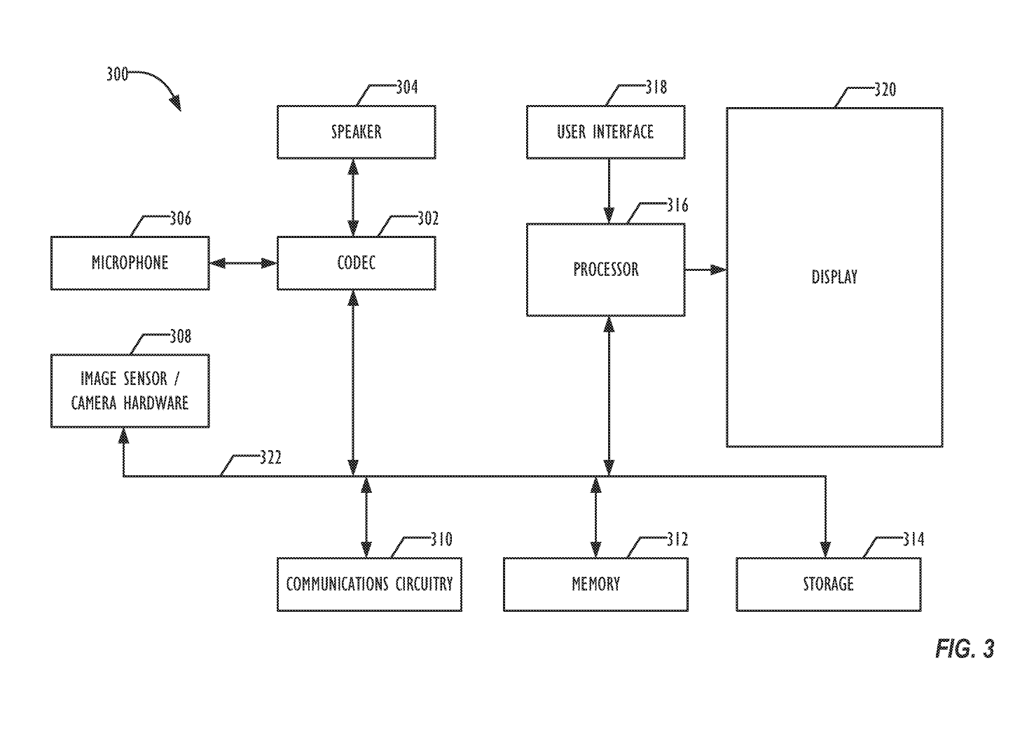

Although as illustrated in FIG. 3, blocks 240, 250, and 260 are all present, variants may incorporate additional checks not illustrated in the figure or may omit any of the checks of blocks 240, 250, and 260.

In block 270, the permissions themselves are evaluated in light of the other information obtained in blocks 240, 250, and 260. If the permissions are deemed excessive, such as when an application similar to the current application usually only needs a subset of the permissions requested by the current application, then the application may be considered risky and a risk level assigned in block 280. Otherwise, the application may be considered not risky or having a low risk.

All or some of the actions of FIG. 2 may be performed locally or remotely, as desired. In some variants, the security service collects relevant information about the application and its permissions, and passes that information to a server for making the determination of riskiness and risk level. In other variants, the security service may perform those actions locally, and pass the application information and the risk level determination to the security server. Other variants may provide a mixture of local and remote processing, as desired, such as attempting to determine a risk level locally, but if sufficient information is not present locally, sending information about the unknown application to the remote server for further analysis.

The security service performing the techniques described above may be implemented as a standalone application or operating system service, or may be bundled as part of a broader security and anti-malware software as desired.

Implementation in an Electronic Device

FIG. 3 is a simplified functional block diagram illustrating an programmable device 300 according to one embodiment that can implement the techniques described above. The programmable device 300 may include a processor 316, display 320, microphone 306, audio/video codecs 302, speaker 304, communications circuitry 310, an image sensor with associated camera hardware 308 for performing image capture, user interface 318, memory 312, storage subsystem 314, and communications bus 322. Processor 316 may be any suitable programmable control device and may control the operation of many functions, such as the installation of software applications, as well as other functions performed by programmable device 300. Processor 316 may drive display 320 and may receive user inputs from the user interface 318. An embedded processor provides a versatile and robust programmable control device that may be utilized for carrying out the disclosed techniques.

Storage subsystem 314 may store media (e.g., image and video files), software (e.g., for implementing various functions on device 300), preference information, device profile information, and any other suitable data. Storage subsystem 314 may include one more storage mediums for tangibly recording image data and program instructions, including for example, a hard-drive, permanent memory such as ROM, semi-permanent memory such as RAM or flash memory, or cache. Program instructions may comprise a software implementation encoded in any desired language (e.g., C or C++).

Memory 312 may include one or more different types of memory which may be used for performing device functions. For example, memory 312 may include cache, ROM, and/or RAM. Communications bus 322 may provide a data transfer path for transferring data to, from, or between at least storage subsystem 314, memory 312, and processor 316. Although referred to as a bus, communications bus 322 is not limited to any specific data transfer technology. User interface 318 may allow a user to interact with the programmable device 300. For example, the user interface 318 can take a variety of forms, such as a button, keypad, dial, a click wheel, or a touch screen.

In one embodiment, the programmable device 300 may be an electronic device capable of providing personal communications. For example, the programmable device 300 may be a device such as such a mobile phone, personal data assistant (PDA), portable music player, monitor, television, laptop, desktop, and tablet computer, or other suitable personal device.

Networked Implementations

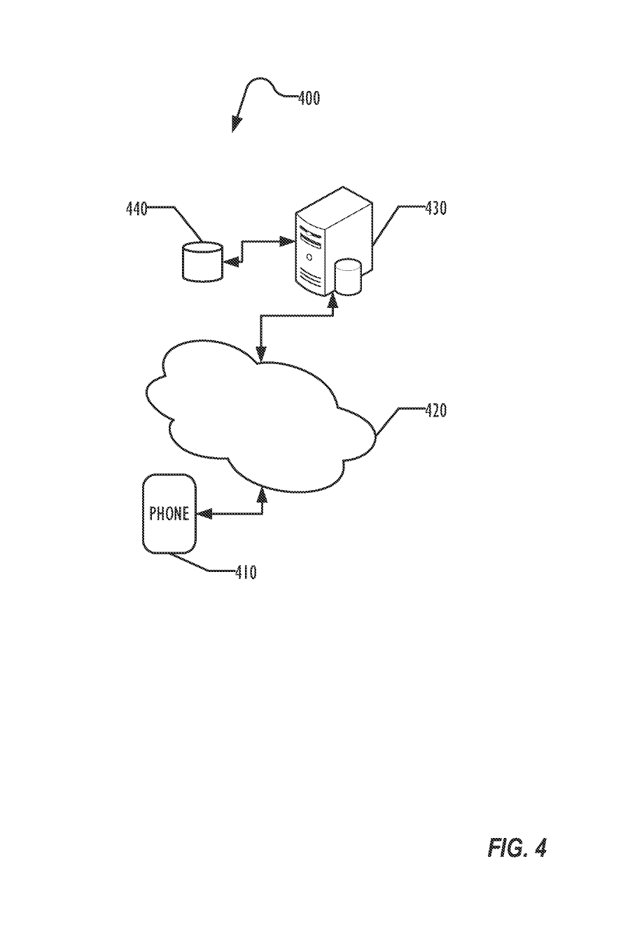

FIG. 4 is a block diagram illustrating a networked implementation of the techniques described above, in this example comprising a smartphone 410 connected as a programmable client device by a network 420 to a remote security server 430, although other types of programmable client devices other than smartphones may implement these techniques. The remote server 430 may be coupled to or include one or more storage subsystems that include databases 440 for use in the evaluation. No particular format or configuration is intended to be implied by the use of the term database, which may employ any type or mixture of types of data storage techniques.

The network 420 may be a wireless network, such as a mobile phone wireless network, a wireless (WiFi) local area network, which may be connected to a wide area network such as the Internet. As described above, the phone 410 may communicate information about an application that is to be installed to the server 430. The server 430 may respond with a risk determination with information about the risk level of the application, or other information that may be used by the phone 410 to determine the risk level. Whitelist or blacklist information may be provided from time to time by the server 430 to the phone 410. In some variants, the phone 410 may perform the analysis and evaluation of the application, but provide the analysis or evaluation results to the server 430 for further analysis or for building a reputation database by the security service vendor.

The server 430 may update the whitelist by sending a revocation notice to cause the client to remove the application from its local whitelist or by sending a revocation notice to remove the application from its local blacklist, as additional information is learned by the server 430.

Similarly, the client 410 may provide updates to a remote whitelist or blacklist, based on analysis of an application by the client 410. Encryption may be used on the communications between the client 410 and server 430, and the whitelists and blacklists may be encrypted on either or both the client 410 and server 430 as desired. Any portion of the techniques described above may be performed on either the phone 410 or the server 430 as desired.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

1. A method, comprising:
receiving a request to install an application on a programmable device; and
deciding whether to install the application, comprising:
determining a risk level of the application responsive to a set of permissions requested by the application, comprising:
determining one or more characteristics of the application;
evaluating the set of permissions requested by the application in relation to the one or more determined characteristics of the application; and
assigning a risk level responsive to the evaluation; and
blocking installation of the application if the risk level exceeds a predetermined risk threshold,
wherein the determined characteristics comprise at least one characteristic not contained in a manifest associated with the application.

2. The method of claim 1, wherein blocking installation comprises:
presenting a warning dialog to a user of the programmable device,
wherein the user can force installation of the application through the dialog.

3. The method of claim 1, wherein determining a risk level of the application further comprises:
parsing a manifest file provided by the application, the manifest file identifying the set of permissions requested by the application;
assigning a risk based on the set of permissions.

4. The method of claim 1, wherein determining a risk level further comprises:
checking a whitelist of known good applications.

5. The method of claim 1, wherein determining a risk level further comprises:
checking a blacklist of known malware applications.

6. The method of claim 1, further comprising:
adding the application to a whitelist.

7. The method of claim 6, further comprising:
encrypting the whitelist.

8. The method of claim 6, wherein the whitelist is local to the programmable device.

9. The method of claim 6, wherein adding the application to a whitelist comprises:
requesting a remote server to add the application to a remote whitelist.

10. The method of claim 6, further comprising:
removing the application from the whitelist responsive to a revocation notice received by the programmable device.

11. The method of claim 1, wherein blocking installation comprises:
adding the application to a blacklist.

12. The method of claim 11, further comprising:
encrypting the blacklist.

13. The method of claim 11, wherein the blacklist is remote to the programmable device.

14. The method of claim 1, further comprising:
receiving an update from a remote server; and
updating a whitelist of known good applications with the update.

15. The method of claim 1, further comprising:
receiving an update from a remote server; and
updating a blacklist of known malware applications with the update.

16. The method of claim 1, wherein determining a risk level comprises:
sending information about the application to a remote server; and
receiving a determination of the risk level from the remote server.

17. A system, comprising:
a processor;
a storage subsystem, coupled to the processor;
an application database stored on the storage subsystem comprising: information associated with applications configured for installation on a programmable client device; and
software stored on the storage subsystem comprising instructions that when executed cause the processor to:
receive a request from the programmable client device responsive to an attempt to install an application on the programmable client device;
determine one or more characteristics of the application;
evaluate a set of permissions requested by the application in relation to the one or more determined characteristics of the application; and
transmit a risk determination to the programmable client device responsive to evaluating the set of permissions,
wherein the one or more determined characteristics comprise at least one characteristic not contained in a manifest associated with the application.

18. The system of claim 17, further comprising:
a whitelist of known good applications,
wherein the instructions that when executed cause the processor to evaluate the set of permissions requested by the application comprise instructions that when executed cause the processor to:
determine whether the application is on the whitelist.

19. The system of claim 17, further comprising:
a blacklist of known mal ware applications,
wherein the instructions that when executed cause the processor to evaluate the set of permissions requested by the application comprise instructions that when executed cause the processor to:
determine whether the application is on the blacklist.

20. The system of claim 17, further comprising:
a whitelist of known good applications; and
a blacklist of known malware applications,
wherein the software further comprises instructions that when executed cause the processor to:
receive a request from the programmable client to add the application to the whitelist or to add the application to the blacklist.

21. The system of claim 17, wherein the software further comprises instructions that when executed cause the processor to:
send an update to the programmable device comprising updates to a whitelist of known good applications or a blacklist of known malware applications maintained local to the programmable device.

22. A programmable device comprising:
a programmable control device;
an operating system configured to control the programmable control device;
a storage subsystem, coupled to the programmable control device; and
software stored on the storage subsystem comprising instructions that when executed by the programmable control device cause the programmable control device to:
evaluate a set of permissions requested by an application to be installed on the programmable device in relation to one or more determined characteristics of the application, to determine a risk level of the application; and
block installation of the application if risk level exceeds a predetermined risk threshold,
wherein the determined characteristics comprise at least one characteristic not contained in a manifest associated with the application.

23. The programmable device of claim 22, wherein the software further comprises instructions that when executed cause the programmable control device to:
identify the risk level to a user of the programmable device; and
ask the user whether to install the application.

24. The programmable device of claim 22, wherein the determined characteristics comprise at least one of:
a categorization of the application in an application marketplace;
a trust level associated with a source of the application;
a number of applications from the source of the application known to be good; and
a functionality of the application.

25. The programmable device of claim 22, wherein the programmable device is a mobile programmable device.

26. The programmable device of claim 22, wherein the software further comprises instructions that when executed cause the programmable control device to:
update a white list or a blacklist responsive to evaluating the set of permissions.

27. The programmable device of claim wherein the software further comprises instructions that when executed cause the programmable control device to:
send information about the application to a remote server.
